(19) United States
(12) Patent Application Publication
(10) Pub. No.: US 2017/0322859 A1
(43) Pub. Date: Nov. 9, 2017

(54) CPU PERFORMANCE PROFILING

(71) Applicant: eBay Inc., San Jose, CA (US)

(72) Inventors: Dmytro Semenov, San Jose, CA (US); Mahesh Kumar Dathrika, Santa Clara, CA (US); Rajasekhar Bhogi, San Jose, CA (US)

(21) Appl. No.: 15/219,716

(22) Filed: Jul. 26, 2016

Related U.S. Application Data
(60) Provisional application No. 62/332,074, filed on May 5, 2016.

(51) Int. Cl. G06F 11/34; G06F 11/30; G06F 11/32

(52) U.S. Cl. CPC G06F 11/3452; G06F 11/327; G06F 11/3024; G06F 11/3051

(57) ABSTRACT

Methods, systems and media for profiling CPU performance are provided. In one example, a method for profiling CPU performance includes generating a CPU profiling data file using a profiling tool, loading a flame graphing tool into a browser, loading the CPU profiling data file into a profiling page of the browser using the flame graphing tool, converting the loaded CPU profiling data file into an aggregated JSON format, and using the flame graphing tool to generate a flame graph using the aggregated JSON data.

### CLAIM OF PRIORITY

This patent application claims the benefit of priority, under 35 U.S.C. Section 119(e), to Semenov et al., U.S. Provisional Patent Application Ser. No. 62/332,074, entitled “CPU PERFORMANCE PROFILING,” filed on May 5, 2016 (Attorney Docket No. 2043.K19PRV), which is hereby incorporated by reference herein in its entirety.

### TECHNICAL FIELD

This application relates generally to CPU performance profiling and, more specifically, to “one-click” CPU performance profiling using flame graphs in web or service applications. In one embodiment, performance analysis of a web or service application is performed using a v8-profiler and a flame graph at run time.

### BACKGROUND

CPU performance analysis can be a challenging task. Conventionally, in order to profile a web or service application one is required to set up a special environment (e.g., Linux, or SmartOS) and use a multi-step process to obtain a flame graph CPU performance profile. This inconvenience can often cause the profiling step to be overlooked by application developers. This oversight can in turn create performance problems during subsequent production phases with application teams being required to spend time on inefficient and time-consuming error identification and correction. This disclosure seeks to provide technical solutions to these problems.

### BRIEF SUMMARY

On-the-fly or on-demand generation of a CPU profile is provided as a flame graph. A v8-profiler is used to generate a CPU profile in an environment (for example, dev, QA, production) that runs Node.js (for example, OSX, Linux, Windows, and so forth). A public algorithm is used to process and aggregate a CPU profile into a JSON format usable by a profiling tool. A public module (for example, https://github.com/cimi/d3-flame-graphs) is used to generate, with one click, a flame graph in a tool such as ValidateInternals.

In an example use case, an application team can deploy code to a pre-production environment and use live mirrored traffic from a production phase to run performance testing and analysis. Periodic one-click generation of a CPU profile and upload to central log repository for later analysis can be performed.

### BRIEF DESCRIPTION OF THE DRAWINGS

In order to identify more easily the discussion of any particular element or act, the most significant digit or digits in a reference number refer to the figure number in which that element is first introduced.

FIG. 1 is a block diagram illustrating a networked system, according to an example embodiment.

FIG. 2 is a block diagram showing for the architectural details of a publication system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 illustrates a conventional flame graph.

FIG. 6 illustrates aspects of sample code (or algorithm), in accordance with some embodiments.

FIG. 7 illustrates profile tabs, in accordance with some embodiments.

FIG. 8 illustrates a flame chart, in accordance with one embodiment.

FIG. 9 illustrates a method, in accordance with one embodiment.

FIGS. 10-11 illustrate comparative aspects of the subject matter, in accordance with an example embodiment.

### DETAILED DESCRIPTION

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“MACHINE-READABLE MEDIUM” in this context refers to a component, device or other tangible media able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

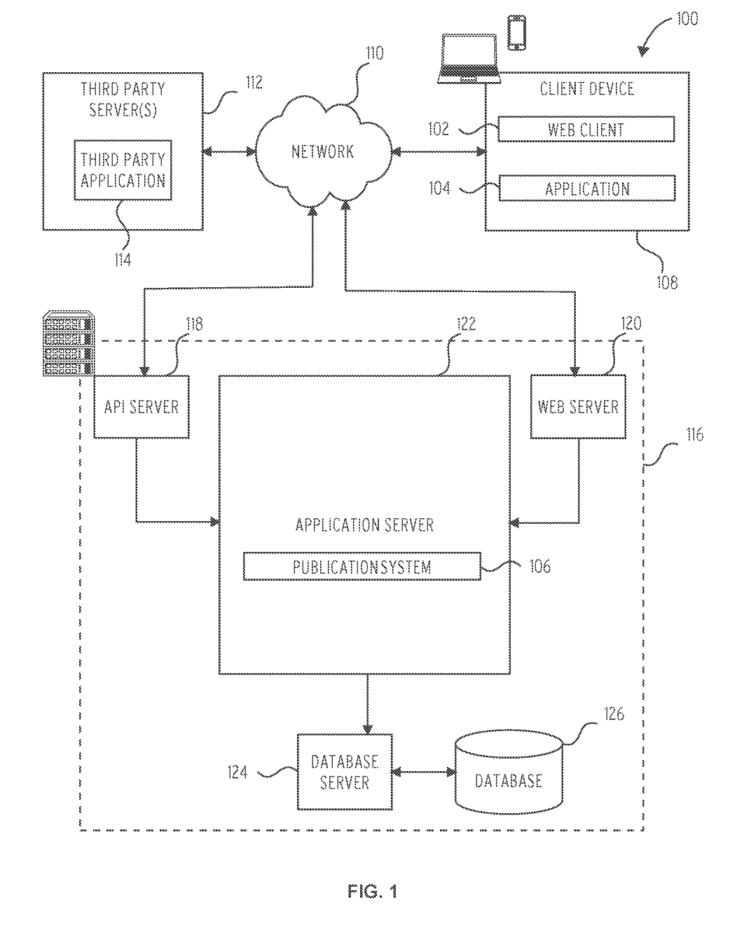

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of an application 104, are hosted and execute on the client device 108. The networked system 116 includes an application server 122, which in turn hosts a publication system 106 that provides a number of functions and services to the application 104 that accesses the networked system 116. The application 104 also provides a number of interfaces described herein, which present output of the tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts a publication system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server(s) 112, is shown as having programmatic access to the networked system 116 via the programmatic interface provided by the Application Program Interface (API) server 118. For example, the third-party application 114, using information retrieved from the networked system 116, may support one or more features or functions on a website hosted by the third party.

Turning now specifically to the applications hosted by the client device 108, the web client 102 may access the various systems (e.g., publication system 106) via the web interface supported by the web server 120. Similarly, the application 104 (e.g., an “app”) accesses the various services and functions provided by the publication system 106 via the programmatic interface provided by the Application Program Interface (API) server 118. The application 104 may be, for example, an “app” executing on a client device 108, such as an iOS or Android OS application to enable a user to access and input data on the networked system 116 in an off-line manner, and to perform batch-mode communications between the programmatic client application 104 and the networked system networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which does not necessarily have networking capabilities.

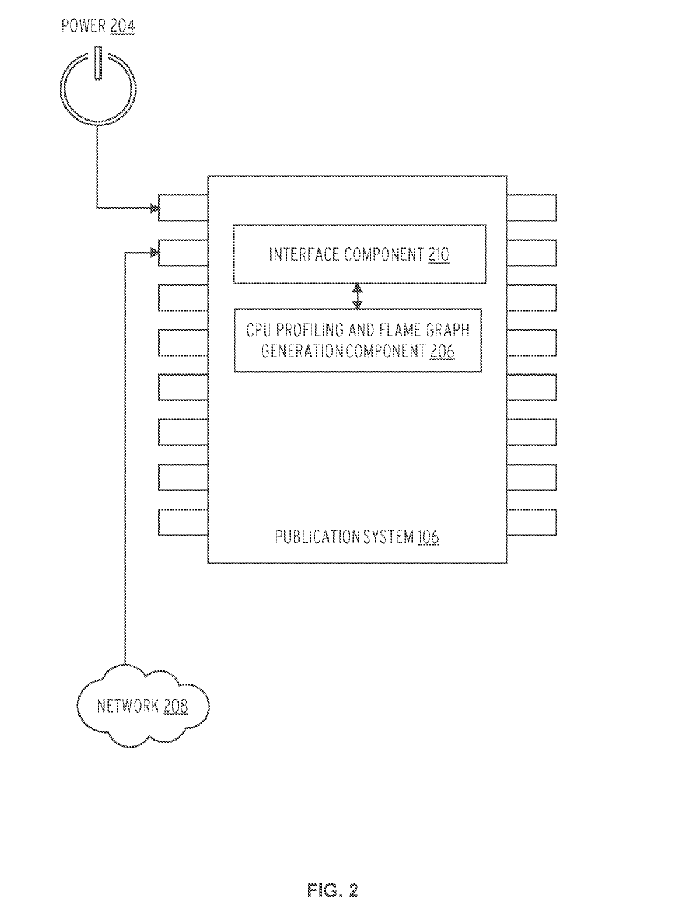

FIG. 2 is a block diagram showing architectural details of a publication system 106, according to some example embodiments. Specifically, the publication system 106 is shown to include an interface component 210 by which the publication system 106 communicates (e.g., over the network 208) with other systems within the SaaS network architecture 100.

The interface component 210 is collectively coupled to a CPU profiling and flame graph generation component 206 that operates to generate a one-click CPU profile and flame graph in accordance with the methods described further below with reference to the accompanying drawings.

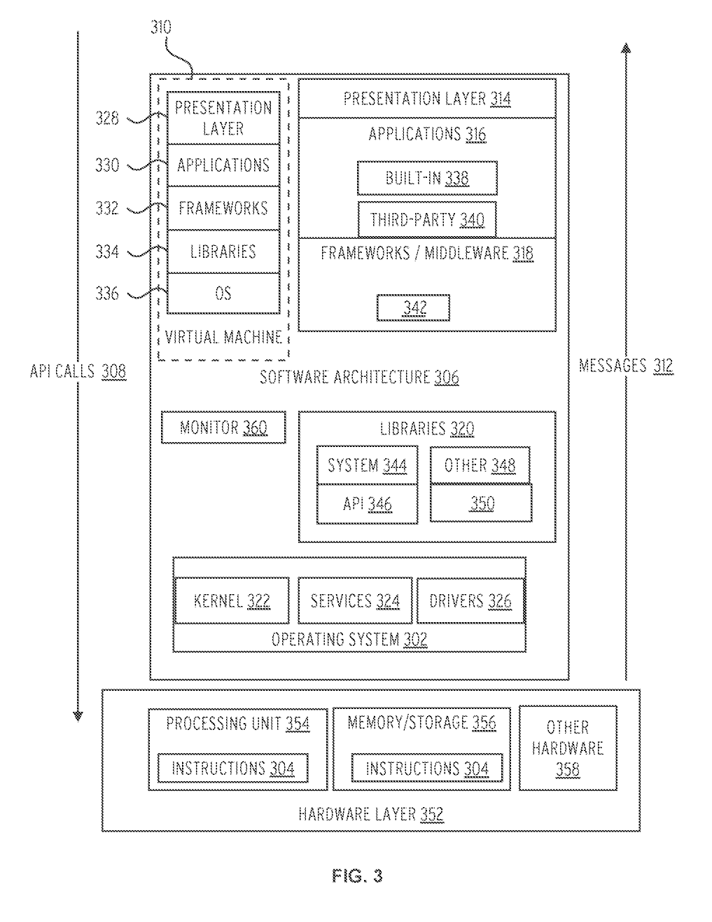

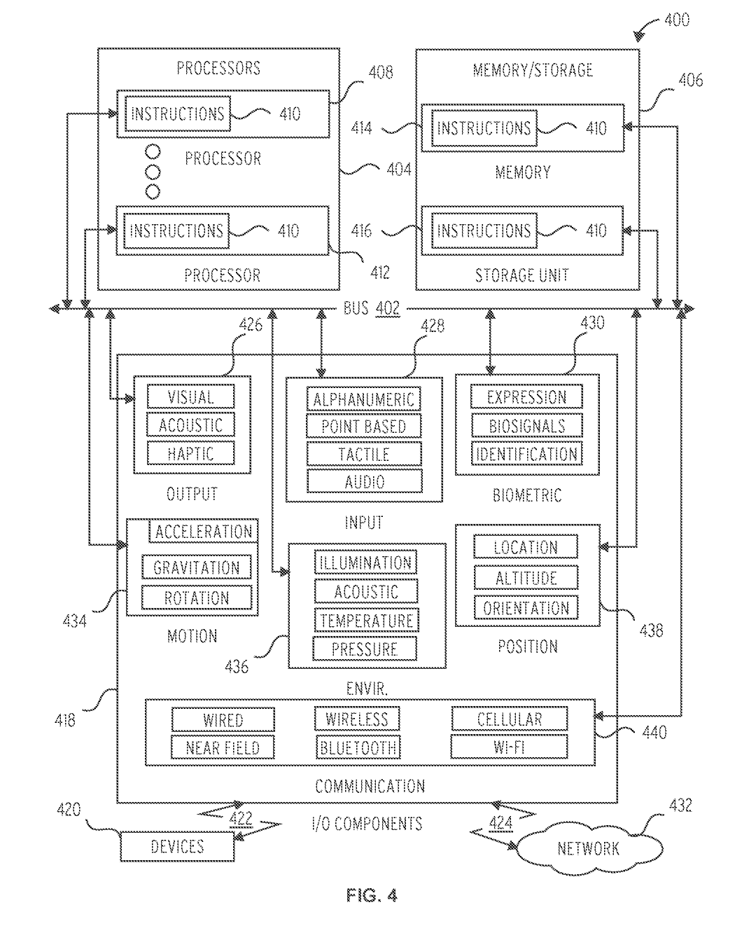

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage modules as memory/storage 356, which also have executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) API calls 308 through the software stack and receive a response as messages 312 in response to the API calls 308. The layers illustrated are representative in nature and not all software architectures have all layers. For example, some mobile or special purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324 and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as operating system 302) to facilitate functionality described herein.

The applications 316 may use built-in operating system functions (e.g., kernel 322, services 324 and/or drivers 326), libraries 320, and frameworks/middleware 318 to create user interfaces to interact with users of the system. Alternatively, or additionally, in some systems, interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system (OS) 336 in FIG. 3) and typically, although not always, has a virtual machine monitor 360, which manages the operation of the virtual machine 310 as well as the interface with the host operating system (i.e., operating system 302). A software architecture executes within the virtual machine 310 such as an operating system (OS) 336, libraries 334, frameworks 332, applications 330 and/or presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via coupling 422 and coupling 424 respectively. For example, the communication components 440 may include a network interface component or other suitable device to interface with the network 432. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a Universal Serial Bus (USB)).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting a NFC beacon signal that may indicate a particular location, and so forth.

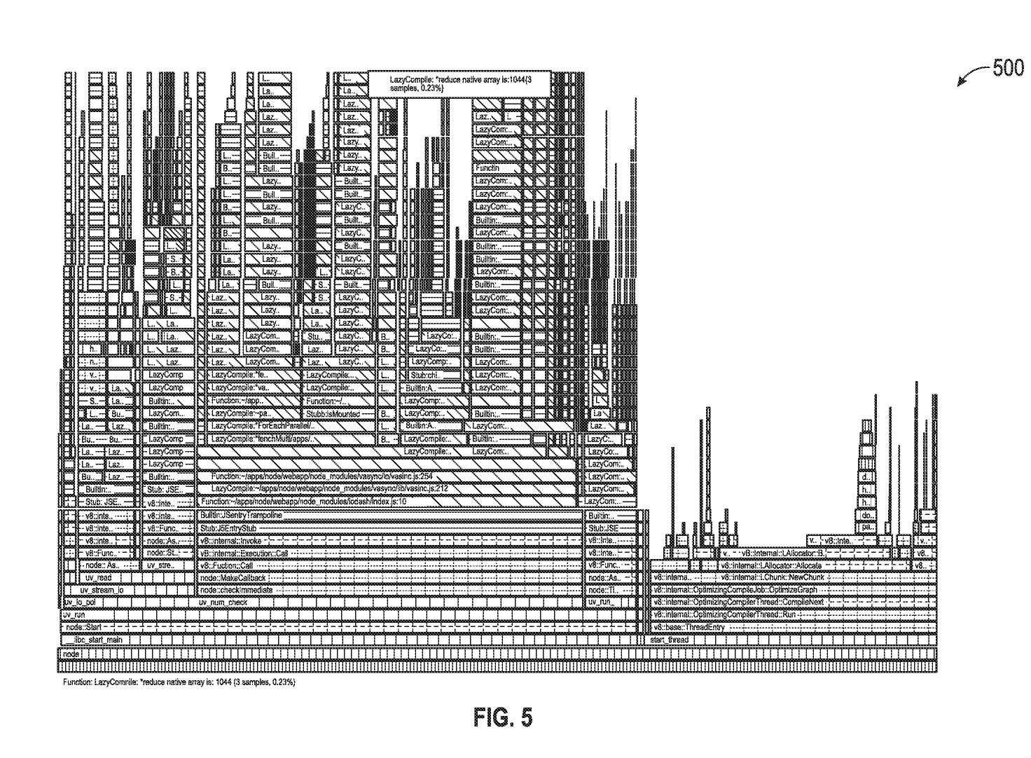

A discussion of conventional flame graph generation is now given. Instructions on how to generate flame graphs using a “perf” (performance) tool are generally known. Kernel tools like DTrace (BSD/Solaris), perf (Linux) can be useful in generating stack traces from the core level and transform the stack calls to flame graphs. This approach can provide a flame graph from Node internals, a V8 engine up to and including JS code. However, successfully running tools like this typically requires a good understanding of the tool itself and sometimes may require a different operating system. For example, a production box and profiling box may be set up completely differently. This can make it difficult to investigate issues arising in production as one has to attempt to reproduce this issue in different environments. If one manages to run conventional tools correctly, one might end up with a conventionally-rendered flame chart 500 as shown in FIG. 5.

Recognized benefits in such an approach can include ease in finding a CPU bottleneck, provision of a graphical view, and a complete profile graph for native and JS frames. Disadvantages can include increased complexity in generating graphs and limited DTrace support offered by different platforms, which can make it harder to profile a CPU in DEV boxes, for example.

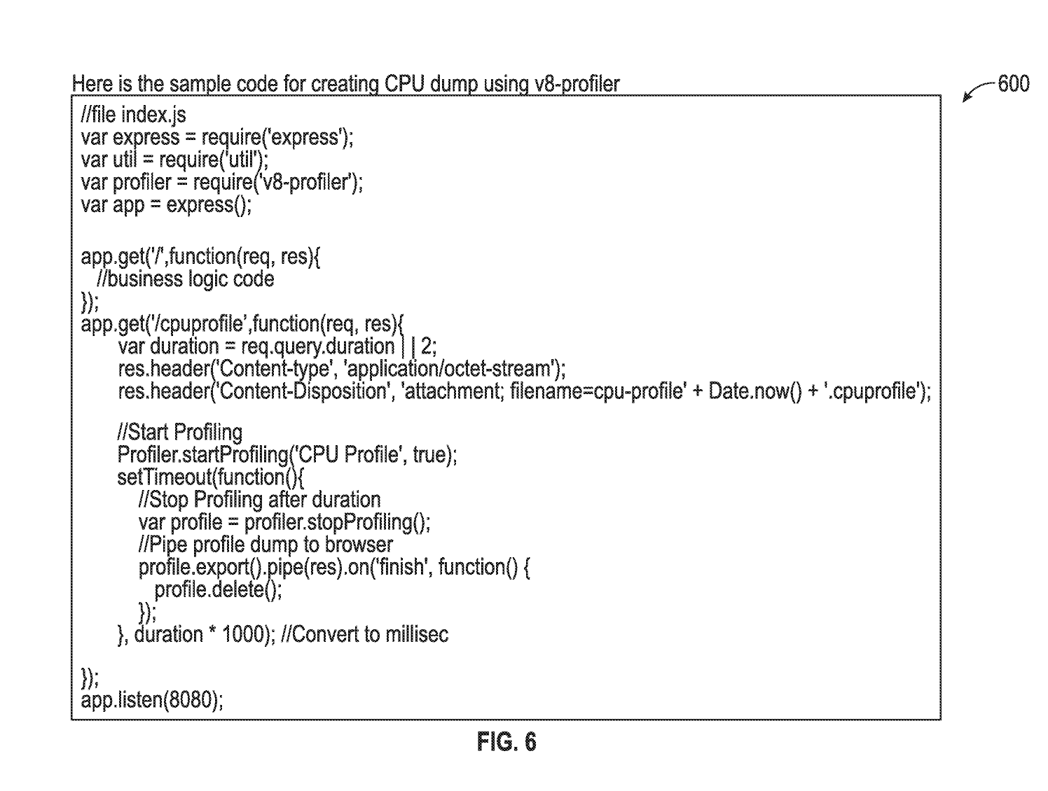

In one embodiment of the present subject matter, a Chrome™ browser is utilized. This browser includes a “V8” engine (or profiler) which can be used in Node.js profiling applications. More specifically, this tool, provided inside Chrome™'s “developer tools,” can be used to profile browser-side JS. The V8-profiler enables use of server-side profile data in a Chrome™ profile tool. However, before using “profiles” in Chrome™, generation of profiling data from a running Node.js application is required. The V8-profiler is used to create CPU profile data. Thus, with reference to FIG. 6, in the illustrated sample code (or algorithm) 600, a route “/cpuprofile” is created for generating CPU profile data for a given number of seconds to create a “dump”. The dump is streamed to an open browser in Chrome™. It will be appreciated that other browsers or routes are possible.

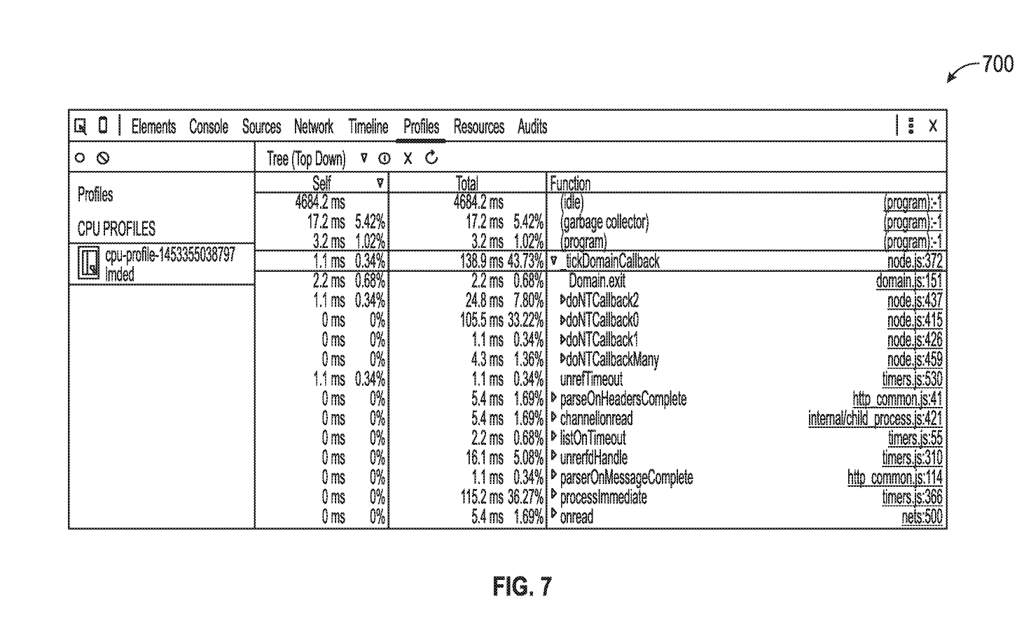

An example CPU profile dump can be accessed via a URL, for example, using http://localhost:8080/cpuprofile?duration=2. On accessing this URL, a file “cpu-profile.cpuprofile” can be downloaded. In one example, on loading the downloaded file in Chrome™ Developer Tools>Profiles>Load, profile tabs 700 of the type shown in FIG. 7 can be created.

Now that profile data has been created, a user can drill down the illustrated tree (showing profile tabs 700) and analyze which piece of code is taking more CPU processing time. With this approach, in one aspect of the present subject matter a user can thus generate profile data with just one click. In comparison to conventional approaches, benefits can include ease in generating a profile dump, platform independence, and an enhanced ability to profile a CPU during live traffic.

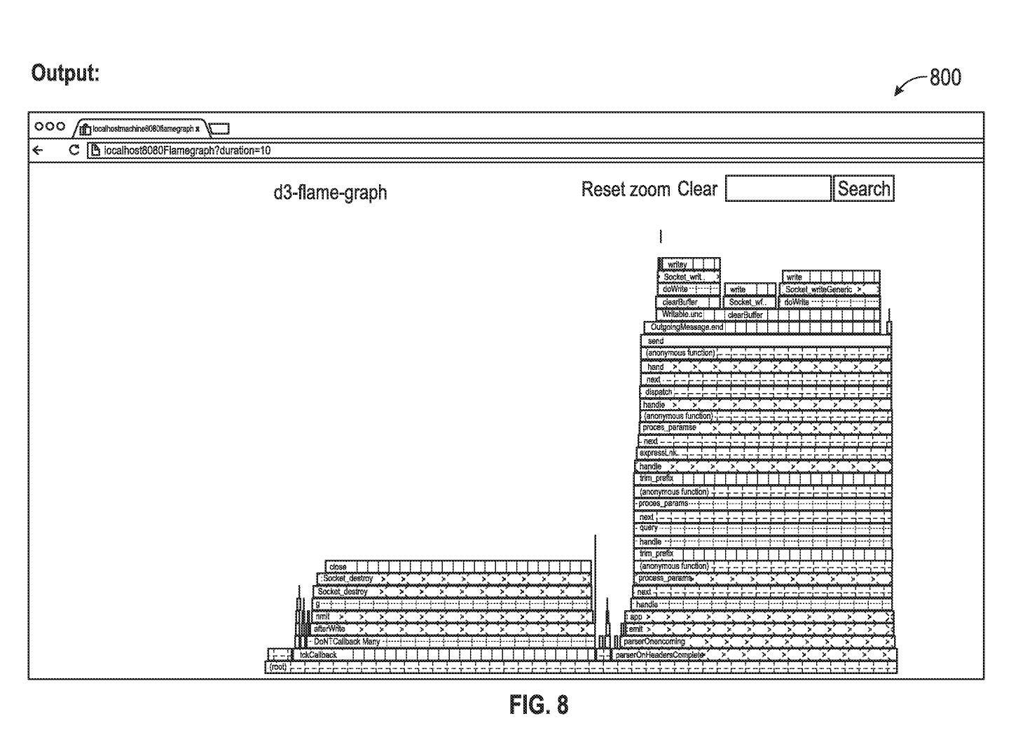

Convenient graphical views such as flame graphs can be generated using, for example, the created V8-profiler data. In one example, an aggregation algorithm is applied to the V8-profiler data and rendered as flame charts using a “d3-flame-graphs” module (such as CPU profiling and flame graph generation component 206). The “.cpuprofile” file mentioned above is, in one example, a JSON file. A “d3-flame-graphs” library can create flame graphs in a browser by inputting JSON data. Loading profile data in a browser using “d3-flame-graphs” renders an outcome such as the example flame chart 800 shown in FIG. 8.

Thus, in one example, a system for profiling CPU performance is provided. The system comprises processors and a memory storing instructions that, when executed by at least one processor among the processors, cause the system to perform operations comprising, at least: generating a CPU profiling data file using a profiling tool; loading a flame graphing tool into a browser; loading the CPU profiling data file into a profiling page of the browser using the flame graphing tool; converting the loaded CPU profiling data file into an aggregated JSON format; and using the flame graphing tool to generate a flame graph using the aggregated JSON data. The CPU profiling data file may include a JSON file. The profiling tool may be a V8-profiler. The flame graphing tool may be a d3-flame-graphs flame graphing tool, and the generated flame graph may include JS frames.

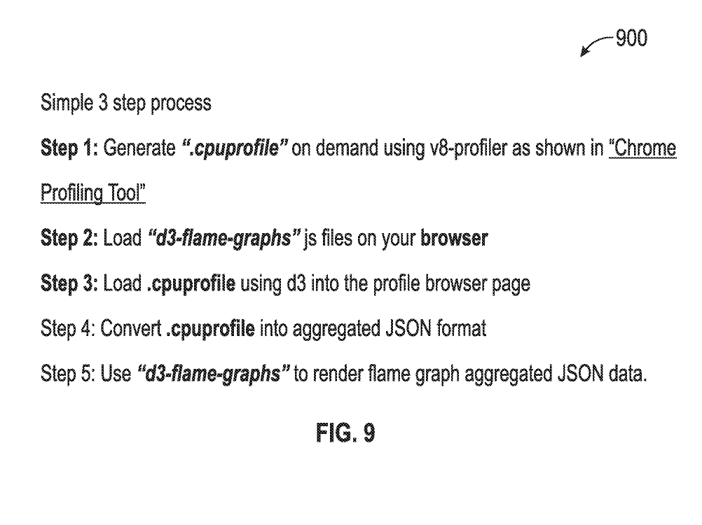

The present subject matter also includes methods. As shown by method 900 in FIG. 9, a CPU profiling method can include a five-step process. Fewer, or more, method steps are possible, and the order may vary somewhat in certain circumstances.

Step 1: Generate a “.cpuprofile” on demand using a V8-profiler, for example as available in a Chrome™ Profiling Tool

Step 2: Load “d3-flame-graphs” js files onto a browser

Step 3: Load a .cpuprofile data file using d3 into the profile browser page

Step 4: Convert the .cpuprofile data file into an aggregated JSON format

Step 5: Use “d3-flame-graphs” to render a flame graph using the aggregated JSON data.

More generally, a method for profiling CPU performance includes generating a CPU profiling data file using a profiling tool; loading a flame graphing tool into a browser; loading the CPU profiling data file into a profiling page of the browser using the flame graphing tool; converting the loaded CPU profiling data file into an aggregated JSON format; and using the flame graphing tool to generate a flame graph using the aggregated JSON data.

As above, the CPU profiling data file may include a JSON file. The profiling tool may be a V8-profiler. The flame graphing tool may be a d3-flame-graphs flame graphing tool, and the generated flame graph may include JS frames.

Returning now to FIG. 8, the illustrated flame chart 800 only shows JS frames, which typically are what most application developers are interested in, but other formats are possible. Benefits of the method 900 include ease and simplicity in generating flame graphs, no special setup is required, platform independence, early performance analysis during development, and the convenience of enabling graphical views capable of being integrated into one or more applications as needed.

The disclosed subject matter has been successfully used to analyze and optimize performance in platform code as well as in many applications that have been rolled into production. For example, the inventors were able quickly to identify performance problems in production for at least one critical application when, after new deployment, it started using 80% of CPU time versus an expected 20-30% of CPU time.

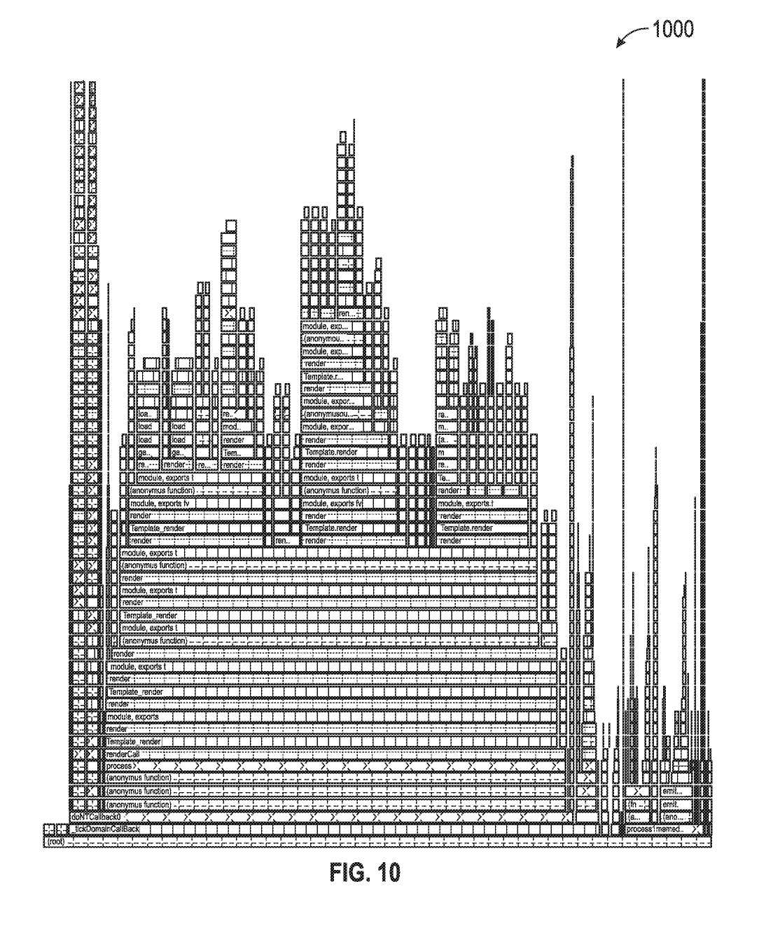

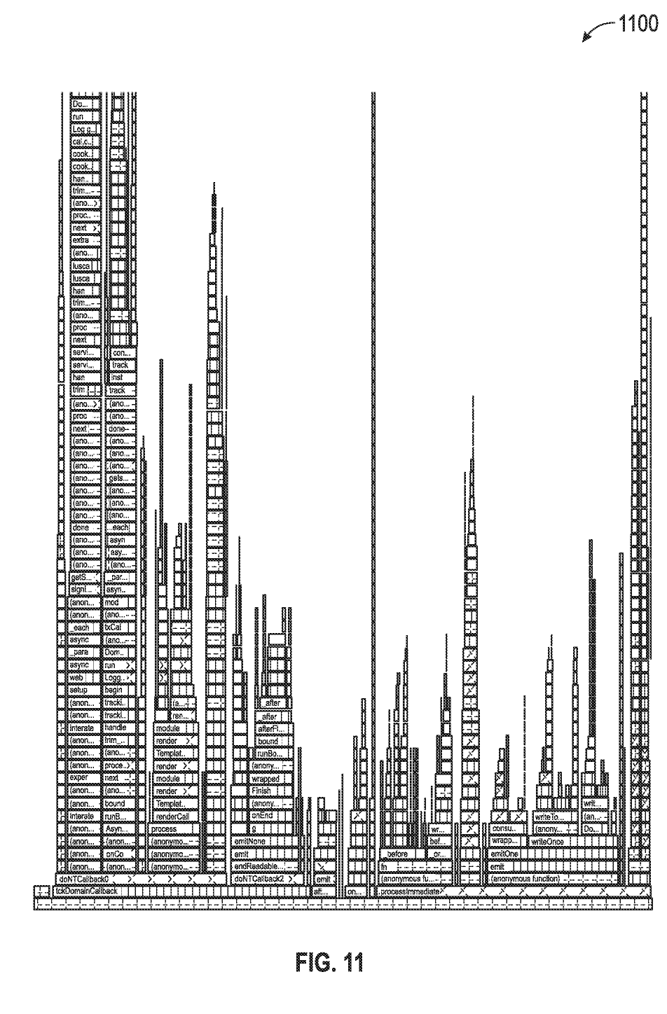

In this regard, and turning now to the view 1000 shown in FIG. 10, a newly deployed application was loading templates over and over again with every user request. The source of the error was quickly identified using the methods of the present disclosure, by noting that the total time spent on template requests was 3500 msec. One fix was to cache the templates at the first load. Other fixes might have been possible. Nevertheless, and with reference to the view 1100 in FIG. 11, the quick identification of the error, facilitated by the present method, enabled a quick identification of a remedy and caused the template rendering operation to be much smaller. The total time spent on template requests became 1100 msec.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for profiling CPU performance, the method comprising:
generating a CPU profiling data file using a profiling tool;
loading a flame graphing tool into a browser;
loading the CPU profiling data file into a profiling page of the browser using the flame graphing tool;
converting the loaded CPU profiling data file into an aggregated JSON format; and
using the flame graphing tool to generate a flame graph using the aggregated JSON data.

2. The method of claim 1, wherein the CPU profiling data file includes a JSON file.

3. The method of claim 1, wherein the profiling tool is a V8-profiler.

4. The method of claim 1, wherein the flame graphing tool is a d3-flame-graphs flame graphing tool.

5. The method of claim 1, wherein the generated flame graph includes JS frames.

6. A system for profiling CPU performance, the system comprising:
processors; and
a memory storing instructions that, when executed by at least one processor among the processors, cause the system to perform operations comprising, at least:
generating a CPU profiling data file using a profiling tool;
loading a flame graphing tool into a browser;
loading the CPU profiling data file into a profiling page of the browser using the flame graphing tool;
converting the loaded CPU profiling data file into an aggregated JSON format; and
using the flame graphing tool to generate a flame graph using the aggregated JSON data.

7. The system of claim 6, wherein the CPU profiling data file includes a JSON file.

8. The system of claim 6, wherein the profiling tool is a V8-profiler.

9. The system of claim 6, wherein the flame graphing tool is a d3-flame-graphs flame graphing tool.

10. The system of claim 6, wherein the generated flame graph includes JS frames.

11. A non-transitory machine-readable medium including instructions that, when read by a machine, cause the machine to perform operations comprising, at least:
generating a CPU profiling data file using a profiling tool;
loading a flame graphing tool into a browser;
loading the CPU profiling data file into a profiling page of the browser using the flame graphing tool;
converting the loaded CPU profiling data file into an aggregated JSON format; and
using the flame graphing tool to generate a flame graph using the aggregated JSON data.

12. The system of claim 11, wherein the CPU profiling data file includes a JSON file.

13. The system of claim 11 wherein the profiling tool is a V8-profiler.

14. The system of claim 11, wherein the flame graphing tool is a d3-flame-graphs flame graphing tool.

15. The system of claim 11, wherein the generated flame graph includes JS frames.
